(19) United States
(12) Patent Application Publication
(10) Pub. No.: US 2012/0066855 A1
(43) Pub. Date: Mar. 22, 2012

(54) COFORM NONWOVEN WEB HAVING MULTIPLE TEXTURES

(76) Inventors: Michael A. Schmidt, Alpharetta, GA (US); Jenny Day, Woodstock, GA (US); David M. Jackson, Alpharetta, GA (US); Megan C.H. Smith, Roswell, GA (US)

(21) Appl. No.: 12/884,813

(22) Filed: Sep. 17, 2010

(51) Int. Cl. B08B 1/00; D04H 13/00; B32B 27/32; B32B 3/26; B32B 3/30

(52) U.S. Cl. 15/209.1; 428/156; 428/88

(57) ABSTRACT

A textured coform nonwoven web is provided that includes a matrix of meltblown fibers and an absorbent material. The coform nonwoven web is textured in that it includes first offsets that extend from the coform web. Further, the first offsets are themselves textured in that upper surfaces of the first offsets include a foundation texture. A continuous region from which the offsets extend further includes a secondary texture that may or may not be different from the foundation texture. The offsets may further include side walls that include a side wall texture. The side wall texture may or may not be different than both the foundation texture and the secondary texture.

### BACKGROUND OF THE INVENTION

Coform nonwoven webs, which are composites of a matrix of meltblown fibers and an absorbent material (e.g., pulp fibers), have been used as an absorbent layer in a wide variety of applications, including absorbent articles, absorbent dry wipes, wet wipes, and mops. Coform nonwoven webs may have a textured surface formed by contacting the meltblown fibers with a foraminous surface having three-dimensional surface contours. Softness and flexibility are important characteristics of coform webs for which improvements are continuously sought. Surface characteristics are important aspects of a coform web for obtaining good softness and flexibility characteristics such as cushiness and drapability.

As such, a need currently exists for a coform nonwoven web having improved surface characteristics for use in a variety of applications.

### SUMMARY OF THE INVENTION

In accordance with one embodiment of the present invention, a coform nonwoven web is disclosed that includes a matrix of meltblown fibers and an absorbent material. The coform nonwoven web is textured in that it includes first offsets that extend from the coform web. Further, the first offsets are themselves textured in that upper surfaces of the first offsets include a foundation texture. A continuous region from which the offsets extend further includes a secondary texture that may or may not be different from the foundation texture. The offsets may further include side walls that include a side wall texture. The side wall texture may or may not be different than both the foundation texture and the secondary texture.

Other features and aspects of the present invention are described in more detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a schematic illustration one embodiment of a method for forming the coform web of the present invention;

FIG. 2 is an illustration of certain features of the apparatus shown in FIG. 1;

FIG. 3 is a cut-away plan view of one embodiment of a multi-textured coform nonwoven web formed according to the present invention;

FIG. 4 is a plan view of a forming surface useful for making the multi-textured coform nonwoven web shown in FIG. 3;

FIG. 5 is a full plan view of the embodiment of a multi-textured coform nonwoven web shown in FIG. 3;

FIG. 6 is a cut-away plan view of another embodiment of a multi-textured coform nonwoven web formed according to the present invention; and

FIG. 7 is a cut-away plan view of a further embodiment of a multi-textured coform nonwoven web formed according to the present invention.

Repeat use of reference characters in the present specification and drawings is intended to represent same or analogous features or elements of the invention.

### DETAILED DESCRIPTION OF REPRESENTATIVE EMBODIMENTS

Reference now will be made in detail to various embodiments of the invention, one or more examples of which are set forth below. Each example is provided by way of explanation, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention cover such modifications and variations.

Generally speaking, the present invention is directed to a coform nonwoven web that contains a matrix of meltblown fibers and an absorbent material. As used herein the term “nonwoven web” generally refers to a web having a structure of individual fibers or threads which are interlaid, but not in an identifiable manner as in a knitted fabric. Examples of nonwoven fabrics or webs include, but are not limited to, meltblown webs, spunbond webs, bonded carded webs, airlaid webs, coform webs, hydraulically entangled webs, and so forth. The term “meltblown web” generally refers to a nonwoven web that is formed by a process in which a molten thermoplastic material is extruded through a plurality of fine, usually circular, die capillaries as molten fibers into converging high velocity gas (e.g., air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, et al., which is incorporated herein in its entirety by reference thereto for all purposes. Generally speaking, meltblown fibers may be microfibers that are substantially continuous or discontinuous, generally smaller than 10 micrometers in diameter, and generally tacky when deposited onto a collecting surface. The term “spunbond web” generally refers to a web containing small diameter substantially continuous fibers. The fibers are formed by extruding a molten thermoplastic material from a plurality of fine, usually circular, capillaries of a spinnerette with the diameter of the extruded fibers then being rapidly reduced as by, for example, eductive drawing and/or other well-known spunbonding mechanisms. The production of spunbond webs is described and illustrated, for example, in U.S. Pat. No. 4,340,563 to Appel, et al., U.S. Pat. No. 3,692,618 to Dorschner, et al., U.S. Pat. No. 3,802,817 to Matsuki, et al., U.S. Pat. No. 3,338,992 to Kinney, U.S. Pat. No. 3,341,394 to Kinney, U.S. Pat. No. 3,502,763 to Hartman, U.S. Pat. No. 3,502,538 to Levy, U.S. Pat. No. 3,542,615 to Dobo, et al., and U.S. Pat. No. 5,382,400 to Pike, et al., which are incorporated herein in their entirety by reference thereto for all purposes. Spunbond fibers are generally not tacky when they are deposited onto a collecting surface. Spunbond fibers may sometimes have diameters less than about 40 micrometers, and are often between about 5 to about 20 micrometers.

Meltblown fibers suitable for use in the fibrous nonwoven coform structure include polyolefins, for example, polyethylene, polypropylene, polybutylene and the like, polyamides, olefin copolymers and polyesters. In accordance with a one embodiment, the meltblown fibrous materials used in the formation of the fibrous nonwoven structure are formed from a thermoplastic composition that contains at least one propylene/a-olefin copolymer of a certain monomer content, density, melt flow rate, etc. The selection of a specific type of propylene/a-olefin copolymer provides the resulting composition with improved thermal properties for forming a coform web. For example, the thermoplastic composition crystallizes at a relatively slow rate, thereby allowing the fibers to remain slightly tacky during formation. This tackiness may provide a variety of benefits, such as enhancing the ability of the meltblown fibers to adhere to the absorbent material during web formation. Due in part to its enhanced bonding capacity, a lower amount of meltblown fibers may also be employed than previously thought needed to form a coherent and self-supporting coform structure. For example, the meltblown fibers may constitute from about 2 wt. % to about 40 wt. %, in some embodiments from 4 wt. % to about 30 wt. %, and in some embodiments, from about 5 wt. % to about 20 wt. % of the coform web. Likewise, the absorbent material may constitute from about 60 wt. % to about 98 wt. %, in some embodiments from 70 wt. % to about 96 wt. %, and in some embodiments, from about 80 wt. % to about 95 wt. % of the coform web.

In addition to enhancing the bonding capacity of the meltblown fibers, the thermoplastic composition of the present invention may also impart other benefits to the resulting coform structure. In certain embodiments, for example, the coform web may be imparted with multiple textures using a three-dimensional forming surface.

In such embodiments, the relatively slow rate of crystallization of the meltblown fibers may increase their ability to conform to the contours of the three-dimensional forming surface. Once the fibers crystallize, however, the meltblown fibers may achieve a degree of stiffness similar to conventional polypropylene, thereby allowing them to retain their three-dimensional shape and form a highly textured surface on the coform web.

Another benefit of the fiber's prolonged tackiness during formation may be an increased ply attachment strength between layers of a multi-ply coform nonwoven web, resulting in additional shear energy being necessary to delaminate the plies. Such increased ply attachment strength may reduce or eliminate the need for embossing that could negatively impact sheet characteristics such as thickness and density. Increased ply attachment strength may be particularly desirable during dispensing of wipers made from a multi-ply coform nonwoven web. Texture imparted by using a three-dimensional forming surface as described herein may further increase the ply attachment strength by increasing the contact surface area between the plies.

The coform nonwoven web is textured in that it includes first offsets that extend from the coform web, forming a pattern texture. The first offsets may have any of a variety of distinct three-dimensional geometric shapes, for example, circles, squares, ovals, arcs, lines, ridges, and so forth, or the offsets may be in the shape of any other distinct shape, for example, clouds, bears, swooshes, letters, numbers, and so forth.

Further, the first offsets may have an upper surface that is itself textured in that the upper surface of the first offsets may include a foundation texture. Foundation textures on the surface of the first offsets may include any distinctive texture, for example, fuzzy texture, rough texture, flat texture, indentation texture, wire texture, dimples, circular dimples, square dimples, pyramids, reverse pyramids, reverse dimples, ovals, arcs, lines, ridges, crossed ridges, channels, other three-dimensional textures, and so forth. In some desirable embodiments the foundation texture is a texture different than a flat texture.

Even further, the textured coform may include a secondary texture formed on a surface of a continuous region between the offsets. Secondary textures on the surface of the continuous region may include any distinctive texture, for example, fuzzy texture, rough texture, flat texture, indentation texture, wire texture, dimples, circular dimples, square dimples, pyramids, reverse pyramids, reverse dimples, ovals, arcs, lines, ridges, crossed ridges, channels, other three-dimensional textures, and so forth. In some desirable embodiments the secondary texture is a texture different than a flat texture.

Moreover, the first offsets may include offset side walls extending from the upper surface of the offset to the surface of the continuous region. The offset side walls may include a wall texture that is different than the foundation texture or the secondary texture. The wall texture may include any distinctive texture, for example, fuzzy texture, rough texture, flat texture, indentation texture, wire texture, dimples, circular dimples, square dimples, pyramids, reverse pyramids, channels, angled channels, cross channels, lines, ridges, crossed ridges, other three dimensional textures, and so forth. In some desirable embodiments the wall texture is a texture different than a flat texture.

In some embodiments, the various textures may be configured to assist fluid absorption into the various surfaces of the coform material. In some further embodiments, the various textures may be configured to assist fluid flow across the various surfaces of the coformed nonwoven material.

Various embodiments of the present invention will now be described in more detail.

### I. Thermoplastic Composition

The meltblown fibers may be formed from any thermoplastic composition suitable for forming meltblown fibers. In one embodiment, the meltblown fibers are formed from a thermoplastic composition which contains at least one copolymer of propylene and an α-olefin, such as a C₂-C₂₀ α-olefin, C₂-C₁₂ α-olefin, or C₂-C₈ α-olefin. Suitable α-olefins may be linear or branched (e.g., one or more C₁-C₃ alkyl branches, or an aryl group). Specific examples include ethylene, butene; 3-methyl-1-butene; 3,3-dimethyl-1-butene; pentene; pentene with one or more methyl, ethyl or propyl substituents; hexene with one or more methyl, ethyl or propyl substituents; heptene with one or more methyl, ethyl or propyl substituents; octene with one or more methyl, ethyl or propyl substituents; nonene with one or more methyl, ethyl or propyl substituents; ethyl, methyl or dimethyl-substituted decene; dodecene; styrene; and so forth. Particularly desired α-olefin comonomers are ethylene, butene (e.g., 1-butene), hexene, and octene (e.g., 1-octene or 2-octene). The propylene content of such copolymers may be from about 60 mole % to about 99.5 mole %, in some embodiments from about 80 mole % to about 99 mole %, and in some embodiments, from about 85 mole % to about 98 mole %. The α-olefin content may likewise range from about 0.5 mole % to about 40 mole %, in some embodiments from about 1 mole % to about 20 mole %, and in some embodiments, from about 2 mole % to about 15 mole %. The distribution of the α-olefin comonomer is typically random and uniform among the differing molecular weight fractions forming the propylene copolymer.

The density of the propylene/α-olefin copolymer may be a function of both the length and amount of the α-olefin. That is, the greater the length of the α-olefin and the greater the amount of α-olefin present, the lower the density of the copolymer. Generally speaking, copolymers with a higher density are better able to retain a three-dimensional structure, while those with a lower density possess better elastomeric properties. Thus, to achieve an optimum balance between texture and stretchability, the propylene/α-olefin copolymer is normally selected to have a density of about 0.86 grams per cubic centimeter (g/cm³) to about 0.90 g/cm³, in some embodiments from about 0.861 to about 0.89 g/cm³, and in some embodiments, from about 0.862 g/cm³ to about 0.88 g/cm³. Further, the density of the thermoplastic composition is normally selected to have a density of about 0.86 grams per cubic centimeter (g/cm³) to about 0.94 g/cm³, in further embodiments from about 0.861 to about 0.92 g/cm³, and in even further embodiments, from about 0.862 g/cm³ to about 0.90 g/cm³.

Any of a variety of known techniques may generally be employed to form the propylene/α-olefin copolymer used in the meltblown fibers. For instance, olefin polymers may be formed using a free radical or a coordination catalyst (e.g., Ziegler-Natta). Preferably, the copolymer is formed from a single-site coordination catalyst, such as a metallocene catalyst. Such a catalyst system produces propylene copolymers in which the comonomer is randomly distributed within a molecular chain and uniformly distributed across the different molecular weight fractions. Metallocene-catalyzed propylene copolymers are described, for instance, in U.S. Pat. No. 7,105,609 to Datta, et al.; U.S. Pat. No. 6,500,563 to Datta, et al.; U.S. Pat. No. 5,539,056 to Yang, et al.; and U.S. Pat. No. 5,596,052 to Resconi, et al., which are incorporated herein in their entirety by reference thereto for all purposes. Examples of metallocene catalysts include bis(n-butylcyclopentadienyl)titanium dichloride, bis(n-butylcyclopentadienyl)zirconium dichloride, bis(cyclopentadienyl)scandium chloride, bis(indenyl)zirconium dichloride, bis(methylcyclopentadienyl)titanium dichloride, bis(methylcyclopentadienyl)zirconium dichloride, cobaltocene, cyclopentadienyltitanium trichloride, ferrocene, hafnocene dichloride, isopropyl(cyclopentadienyl,-1-flourenyl)zirconium dichloride, molybdocene dichloride, nickelocene, niobocene dichloride, ruthenocene, titanocene dichloride, zirconocene chloride hydride, zirconocene dichloride, and so forth. Polymers made using metallocene catalysts typically have a narrow molecular weight range. For instance, metallocene-catalyzed polymers may have polydispersity numbers (M_{w}/Mₙ) of below 4, controlled short chain branching distribution, and controlled isotacticity.

In particular embodiments the propylene/α-olefin copolymer constitutes about 50 wt. % or more, in further embodiments about from 60 wt. % or more, and in even further embodiments, about 75 wt. % or more of the thermoplastic composition used to form the meltblown fibers. In other embodiments the propylene/α-olefin copolymer constitutes at least about 1 wt. % and less than about 49 wt. %, in particular embodiments from at least about 1% and less than about 45 wt. %, in further embodiments from at least about 5% and less than about 45 wt. %, and in even further embodiments, from at least about 5 wt. % and less than about 35 wt. % of the thermoplastic composition used to form the meltblown fibers. Of course, other thermoplastic polymers may also be used to form the meltblown fibers so long as they do not adversely affect the desired properties of the composite. For example, the meltblown fibers may contain other polyolefins (e.g., polypropylene, polyethylene, etc.), polyesters, polyurethanes, polyamides, block copolymers, and so forth. In one embodiment, the meltblown fibers may contain an additional propylene polymer, such as homopolypropylene or a copolymer of propylene. The additional propylene polymer may, for instance, be formed from a substantially isotactic polypropylene homopolymer or a copolymer containing equal to or less than about 10 weight percent of other monomer, i.e., at least about 90% by weight propylene. Such a polypropylene may be present in the form of a graft, random, or block copolymer and may be predominantly crystalline in that it has a sharp melting point above about 110° C., in some embodiments about above 115° C., and in some embodiments, above about 130° C. Examples of such additional polypropylenes are described in U.S. Pat. No. 6,992,159 to Datta, et al., which is incorporated herein in its entirety by reference thereto for all purposes.

In particular embodiments, additional polymer(s) may constitute from about 0.1 wt. % to about 50 wt. %, in further embodiments from about 0.5 wt. % to about 40 wt. %, and in even further embodiments, from about 1 wt. % to about 30 wt. % of the thermoplastic composition. Likewise, the above-described propylene/α-olefin copolymer may constitute from about 50 wt. % to about 99.9 wt. %, in further embodiments from about 60 wt. % to about 99.5 wt. %, and in even further embodiments, from about 75 wt. % to about 99 wt. % of the thermoplastic composition.

In other embodiments, additional polymer(s) may constitute from greater than about 50 wt %, in particular embodiments from about 50 wt % to about 99 wt %, in selected embodiments from about 55 wt % to about 99 wt %, in further embodiments from about 55 wt. % to about 95 wt. %, and in even further embodiments from about 65 wt % to about 95 wt %. Likewise, the above described propylene/α-olefin copolymer may constitute from less than about 49 wt %, in particular embodiments from about 1 wt. % to about 49 wt. %, in selected embodiments from about 1 wt. % to about 45 wt. %, in further embodiments from about 5 wt. % to about 45 wt. %, and in even further embodiments, from about 5 wt. % to about 35 wt. % of the thermoplastic composition.

The thermoplastic composition used to form the meltblown fibers may also contain other additives as is known in the art, such as melt stabilizers, processing stabilizers, heat stabilizers, light stabilizers, antioxidants, heat aging stabilizers, whitening agents, etc. Phosphite stabilizers (e.g., IRGAFOS available from Ciba Specialty Chemicals of Terrytown, New York and DOVERPHOS available from Dover Chemical Corp. of Dover, Ohio) are exemplary melt stabilizers. In addition, hindered amine stabilizers (e.g., CHIMASSORB available from Ciba Specialty Chemicals) are exemplary heat and light stabilizers. Further, hindered phenols are commonly used as an antioxidant. Some suitable hindered phenols include those available from Ciba Specialty Chemicals of under the trade name “Irganox®”, such as Irganox® 1076, 1010, or E 201. When employed, such additives (e.g., antioxidant, stabilizer, etc.) may each be present in an amount from about 0.001 wt. % to about 15 wt. %, in some embodiments, from about 0.005 wt. % to about 10 wt. %, and in some embodiments, from 0.01 wt. % to about 5 wt. % of the thermoplastic composition used to form the meltblown fibers.

Through the selection of certain polymers and their content, the resulting thermoplastic composition may possess thermal properties superior to polypropylene homopolymers conventionally employed in meltblown webs. For example, the thermoplastic composition is generally more amorphous in nature than polypropylene homopolymers conventionally employed in meltblown webs. For this reason, the rate of crystallization of the thermoplastic composition is slower, as measured by its “crystallization half-time”—i.e., the time required for one-half of the material to become crystalline. For example, the thermoplastic composition typically has a crystallization half-time of greater than about 5 minutes, in some embodiments from about 5.25 minutes to about 20 minutes, and in some embodiments, from about 5.5 minutes to about 12 minutes, determined at a temperature of 125° C. To the contrary, conventional polypropylene homopolymers often have a crystallization half-time of 5 minutes or less. Further, the thermoplastic composition may have a melting temperature (“Tₘ”) of from about 100° C. to about 250° C., in some embodiments from about 110° C. to about 200° C., and in some embodiments, from about 140° C. to about 180° C. The thermoplastic composition may also have a crystallization temperature (“T_{c}”) (determined at a cooling rate of 10° C./min) of from about 50° C. to about 150° C., in some embodiments from about 80° C. to about 140° C., and in some embodiments, from about 100° C. to about 120° C. The crystallization half-time, melting temperature, and crystallization temperature may be determined using differential scanning calorimetry (“DSC”) as is well known to those skilled in the art and described in more detail below.

The melt flow rate of the thermoplastic composition may also be selected within a certain range to optimize the properties of the resulting meltblown fibers. The melt flow rate is the weight of a polymer (in grams) that may be forced through an extrusion rheometer orifice (0.0825-inch diameter) when subjected to a force of 2160 grams in 10 minutes at 230° C. Generally speaking, the melt flow rate is high enough to improve melt processability, but not so high as to adversely interfere with the binding properties of the fibers to the absorbent material. Thus, in most embodiments of the present invention, the thermoplastic composition has a melt flow rate of from about 120 to about 6000 grams per 10 minutes, in some embodiments from about 150 to about 3000 grams per 10 minutes, and in some embodiments, from about 170 to about 1500 grams per 10 minutes, measured in accordance with ASTM Test Method D1238-E.

### II. Meltblown Fibers

The meltblown fibers may be monocomponent or multicomponent. Monocomponent fibers are generally formed from a polymer or blend of polymers extruded from a single extruder. Multicomponent fibers are generally formed from two or more polymers (e.g., bicomponent fibers) extruded from separate extruders. The polymers may be arranged in substantially constantly positioned distinct zones across the cross-section of the fibers. The components may be arranged in any desired configuration, such as sheath-core, side-by-side, pie, island-in-the-sea, three island, bull's eye, or various other arrangements known in the art. Various methods for forming multicomponent fibers are described in U.S. Pat. No. 4,789,592 to Taniguchi et al. and U.S. Pat. No. 5,336,552 to Strack et al., U.S. Pat. No. 5,108,820 to Kaneko, et al., U.S. Pat. No. 4,795,668 to Kruege, et al., U.S. Pat. No. 5,382,400 to Pike, et al., U.S. Pat. No. 5,336,552 to Strack, et al., and U.S. Pat. No. 6,200,669 to Marmon, et al., which are incorporated herein in their entirety by reference thereto for all purposes. Multicomponent fibers having various irregular shapes may also be formed, such as described in U.S. Pat. No. 5,277,976 to Hogle, et al., U.S. Pat. No. 5,162,074 to Hills, U.S. Pat. No. 5,466,410 to Hills, U.S. Pat. No. 5,069,970 to Largman, et al., and U.S. Pat. No. 5,057,368 to Largman, et al., which are incorporated herein in their entirety by reference thereto for all purposes.

### III. Absorbent Material

Any absorbent material may generally be employed in the coform nonwoven web, such as absorbent fibers, particles, etc. In one embodiment, the absorbent material includes fibers formed by a variety of pulping processes, such as kraft pulp, sulfite pulp, thermomechanical pulp, etc. The pulp fibers may include softwood fibers having an average fiber length of greater than 1 mm and particularly from about 2 to 5 mm based on a length-weighted average. Such softwood fibers can include, but are not limited to, northern softwood, southern softwood, redwood, red cedar, hemlock, pine (e.g., southern pines), spruce (e.g., black spruce), combinations thereof, and so forth. Exemplary commercially available pulp fibers suitable for the present invention include those available from

Weyerhaeuser Co. of Federal Way, Wash. under the designation “Weyco CF-405.” Hardwood fibers, such as eucalyptus, maple, birch, aspen, and so forth, can also be used. In certain instances, eucalyptus fibers may be particularly desired to increase the softness of the web. Eucalyptus fibers can also enhance the brightness, increase the opacity, and change the pore structure of the web to increase its wicking ability. Moreover, if desired, secondary fibers obtained from recycled materials may be used, such as fiber pulp from sources such as, for example, newsprint, reclaimed paperboard, and office waste. Further, other natural fibers can also be used in the present invention, such as abaca, sabai grass, milkweed floss, pineapple leaf, and so forth. In addition, in some instances, synthetic fibers can also be utilized.

Besides or in conjunction with pulp fibers, the absorbent material may also include a superabsorbent that is in the form fibers, particles, gels, etc. Generally speaking, superabsorbents are water-swellable materials capable of absorbing at least about 20 times its weight and, in some cases, at least about 30 times its weight in an aqueous solution containing 0.9 weight percent sodium chloride. The superabsorbent may be formed from natural, synthetic and modified natural polymers and materials. Examples of synthetic superabsorbent polymers include the alkali metal and ammonium salts of poly(acrylic acid) and poly(methacrylic acid), poly(acrylamides), poly(vinyl ethers), maleic anhydride copolymers with vinyl ethers and alpha-olefins, poly(vinyl pyrrolidone), poly(vinylmorpholinone), poly(vinyl alcohol), and mixtures and copolymers thereof. Further, superabsorbents include natural and modified natural polymers, such as hydrolyzed acrylonitrile-grafted starch, acrylic acid grafted starch, methyl cellulose, chitosan, carboxymethyl cellulose, hydroxypropyl cellulose, and the natural gums, such as alginates, xanthan gum, locust bean gum and so forth. Mixtures of natural and wholly or partially synthetic superabsorbent polymers may also be useful in the present invention. Particularly suitable superabsorbent polymers are HYSORB 8800AD (BASF of Charlotte, N.C. and FAVOR SXM 9300 (available from Degussa Superabsorber of Greensboro, N.C.).

### IV. Coform Technique

The coform web of the present invention is generally made by a process in which at least one meltblown die head (e.g., two) is arranged near a chute through which the absorbent material is added while the web forms. Some examples of such coform techniques are disclosed in U.S. Pat. No. 4,100,324 to Anderson, et al.; U.S. Pat. No. 5,350,624 to Georger, et al.; and U.S. Pat. No. 5,508,102 to Georger, et al., as well as U.S. Patent Application Publication Nos. 2003/0200991 to Keck, et al. 2007/0049153 to Dunbar, et al., and 2009/0233072 to Harvey et al., all of which are incorporated herein in their entirety by reference thereto for all purposes.

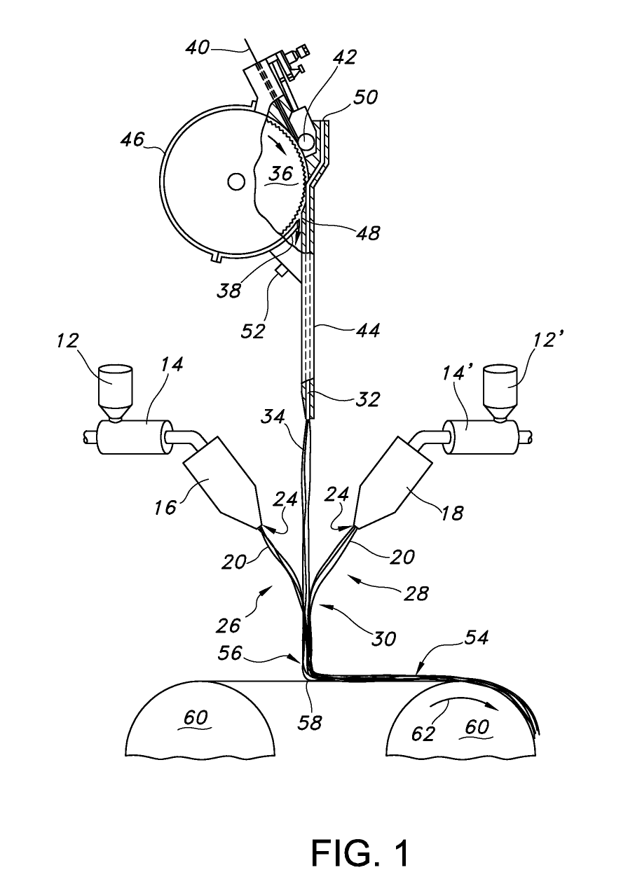

Referring to FIG. 1, for example, one embodiment of an apparatus is shown for forming a coform web of the present invention. In this embodiment, the apparatus includes a pellet hopper 12 or 12′ of an extruder 14 or 14′, respectively, into which a propylene/α-olefin thermoplastic composition may be introduced. The extruders 14 and 14′ each have an extrusion screw (not shown), which is driven by a conventional drive motor (not shown). As the polymer advances through the extruders 14 and 14′, it is progressively heated to a molten state due to rotation of the extrusion screw by the drive motor. Heating may be accomplished in a plurality of discrete steps with its temperature being gradually elevated as it advances through discrete heating zones of the extruders 14 and 14′ toward two meltblowing dies 16 and 18, respectively. The meltblowing dies 16 and 18 may be yet another heating zone where the temperature of the thermoplastic resin is maintained at an elevated level for extrusion.

When two or more meltblowing die heads are used, such as described above, it should be understood that the fibers produced from the individual die heads may be different types of fibers. That is, one or more of the size, shape, or polymeric composition may differ, and furthermore the fibers may be monocomponent or multicomponent fibers. For example, larger fibers may be produced by the first meltblowing die head, such as those having an average diameter of about 10 micrometers or more, in some embodiments about 15 micrometers or more, and in some embodiments, from about 20 to about 50 micrometers, while smaller fibers may be produced by the second die head, such as those having an average diameter of about 10 micrometers or less, in some embodiments about 7 micrometers or less, and in some embodiments, from about 2 to about 6 micrometers. In addition, it may be desirable that each die head extrude approximately the same amount of polymer such that the relative percentage of the basis weight of the coform nonwoven web material resulting from each meltblowing die head is substantially the same. Alternatively, it may also be desirable to have the relative basis weight production skewed, such that one die head or the other is responsible for the majority of the coform web in terms of basis weight. As a specific example, for a meltblown fibrous nonwoven web material having a basis weight of 1.0 ounces per square yard or “osy” (34 grams per square meter or “gsm”), it may be desirable for the first meltblowing die head to produce about 30 percent of the basis weight of the meltblown fibrous nonwoven web material, while one or more subsequent meltblowing die heads produce the remainder 70 percent of the basis weight of the meltblown fibrous nonwoven web material. Generally speaking, the overall basis weight of the coform nonwoven web is from about 10 gsm to about 350 gsm, and more particularly from about 17 gsm to about 200 gsm, and still more particularly from about 25 gsm to about 150 gsm.

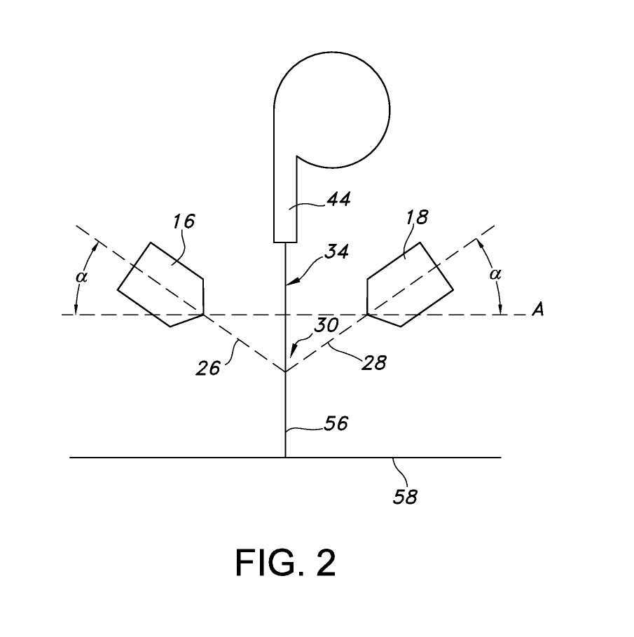

Each meltblowing die 16 and 18 is configured so that two streams of attenuating gas per die converge to form a single stream of gas which entrains and attenuates molten threads 20 and 21 as they exit small holes or orifices 24 in each meltblowing die. The molten threads 20 and 21 are formed into fibers or, depending upon the degree of attenuation, microfibers, of a small diameter which is usually less than the diameter of the orifices 24. Thus, each meltblowing die 16 and 18 has a corresponding single stream of gas 26 and 28 containing entrained thermoplastic polymer fibers. The gas streams 26 and 28 containing polymer fibers are aligned to converge at an impingement zone 30. Typically, the meltblowing die heads 16 and 18 are arranged at a certain angle with respect to the forming surface, such as described in U.S. Pat. Nos. 5,508,102 and 5,350,624 to Georger et al. Referring to FIG. 2, for example, the meltblown dies 16 and 18 may be oriented at an angle α as measured from a plane “A” tangent to the two dies 16 and 18. As shown, the plane “A” is generally parallel to the forming surface 58 (FIG. 1). Typically, each die 16 and 18 is set at an angle ranging from about 30 to about 75 degrees, in some embodiments from about 35° to about 60°, and in some embodiments from about 45° to about 55°. The dies 16 and 18 may be oriented at the same or different angles. In fact, the texture of the coform web may actually be enhanced by orienting one die at an angle different than another die.

Referring again to FIG. 1, absorbent fibers 32 (e.g., pulp fibers) are added to the two streams 26 and 28 of thermoplastic polymer fibers 20 and 21, respectively, and at the impingement zone 30. Introduction of the absorbent fibers 32 into the two streams 26 and 28 of thermoplastic polymer fibers 20 and 21, respectively, is designed to produce a graduated distribution of absorbent fibers 32 within the combined streams 26 and 28 of thermoplastic polymer fibers. This may be accomplished by merging a secondary gas stream 34 containing the absorbent fibers 32 between the two streams 26 and 28 of thermoplastic polymer fibers 20 and 21 so that all three gas streams converge in a controlled manner. Because they remain relatively tacky and semi-molten after formation, the meltblown fibers 20 and 21 may simultaneously adhere and entangle with the absorbent fibers 32 upon contact therewith to form a coherent nonwoven structure.

To accomplish the merger of the fibers, any conventional equipment may be employed, such as a picker roll 36 arrangement having a plurality of teeth 38 adapted to separate a mat or batt 40 of absorbent fibers into the individual absorbent fibers. When employed, the sheets or mats 40 of fibers 32 are fed to the picker roll 36 by a roller arrangement 42. After the teeth 38 of the picker roll 36 have separated the mat of fibers into separate absorbent fibers 32, the individual fibers are conveyed toward the stream of thermoplastic polymer fibers through a nozzle 44. A housing 46 encloses the picker roll 36 and provides a passageway or gap 48 between the housing 46 and the surface of the teeth 38 of the picker roll 36. A gas, for example, air, is supplied to the passageway or gap 46 between the surface of the picker roll 36 and the housing 48 by way of a gas duct 50. The gas duct 50 may enter the passageway or gap 46 at the junction 52 of the nozzle 44 and the gap 48. The gas is supplied in sufficient quantity to serve as a medium for conveying the absorbent fibers 32 through the nozzle 44. The gas supplied from the duct 50 also serves as an aid in removing the absorbent fibers 32 from the teeth 38 of the picker roll 36. The gas may be supplied by any conventional arrangement such as, for example, an air blower (not shown). It is contemplated that additives and/or other materials may be added to or entrained in the gas stream to treat the absorbent fibers. The individual absorbent fibers 32 are typically conveyed through the nozzle 44 at about the velocity at which the absorbent fibers 32 leave the teeth 38 of the picker roll 36. In other words, the absorbent fibers 32, upon leaving the teeth 38 of the picker roll 36 and entering the nozzle 44, generally maintain their velocity in both magnitude and direction from the point where they left the teeth 38 of the picker roll 36. Such an arrangement, which is discussed in more detail in U.S. Pat. No. 4,100,324 to Anderson, et al.

If desired, the velocity of the secondary gas stream 34 may be adjusted to achieve coform structures of different properties. For example, when the velocity of the secondary gas stream is adjusted so that it is greater than the velocity of each stream 26 and 28 of thermoplastic polymer fibers 20 and 21 upon contact at the impingement zone 30, the absorbent fibers 32 are incorporated in the coform nonwoven web in a gradient structure. That is, the absorbent fibers 32 have a higher concentration between the outer surfaces of the coform nonwoven web than at the outer surfaces. On the other hand, when the velocity of the secondary gas stream 34 is less than the velocity of each stream 26 and 28 of thermoplastic polymer fibers 20 and 21 upon contact at the impingement zone 30, the absorbent fibers 32 are incorporated in the coform nonwoven web in a substantially homogenous fashion. That is, the concentration of the absorbent fibers is substantially the same throughout the coform nonwoven web. This is because the low-speed stream of absorbent fibers is drawn into a high-speed stream of thermoplastic polymer fibers to enhance turbulent mixing which results in a consistent distribution of the absorbent fibers.

To convert the composite stream 56 of thermoplastic polymer fibers 20, 21 and absorbent fibers 32 into a coform nonwoven structure 54, a collecting device is located in the path of the composite stream 56. The collecting device may be a forming surface 58 (e.g., belt, drum, wire, fabric, etc.) driven by rollers 60 and that is rotating as indicated by the arrow 62 in FIG. 1. The merged streams of thermoplastic polymer fibers and absorbent fibers are collected as a coherent matrix of fibers on the surface of the forming surface 58 to form the coform nonwoven web 54. If desired, a vacuum box (not shown) may be employed to assist in drawing the near molten meltblown fibers onto the forming surface 58. The resulting textured coform structure 54 is coherent and may be removed from the forming surface 58 as a self-supporting nonwoven material.

It should be understood that the present invention is by no means limited to the above-described embodiments. In an alternative embodiment, for example, first and second meltblowing die heads may be employed that extend substantially across a forming surface in a direction that is substantially transverse to the direction of movement of the forming surface. The die heads may likewise be arranged in a substantially vertical disposition, i.e., perpendicular to the forming surface, so that the thus-produced meltblown fibers are blown directly down onto the forming surface. Such a configuration is well known in the art and described in more detail in, for instance, U.S. Patent Application Publication No. 2007/0049153 to Dunbar, et al. Furthermore, although the above-described embodiments employ multiple meltblowing die heads to produce fibers of differing sizes, a single die head may also be employed. An example of such a process is described, for instance, in U.S. Patent Application Publication No. 2005/0136781 to Lassig, et al., which is incorporated herein in its entirety by reference thereto for all purposes.

As indicated above, it is desired in certain cases to form a coform web that is textured. Referring again to FIG. 1, for example, one embodiment of the present invention employs a forming surface 58 that is foraminous in nature so that the fibers may be drawn through the openings of the surface and form dimensional cloth-like tufts or offsets projecting from the surfaces of the material that correspond to the openings in the forming surface 58. The foraminous surface may be provided by any material that provides sufficient openings for penetration by some of the fibers, such as a highly permeable forming wire. Wire weave geometry and processing conditions may be used to alter the texture or offsets of the material. The particular choice will depend on the desired peak size, shape, depth, surface offset “density” (that is, the number of peaks or offsets per unit area), etc. In one embodiment, for example, the wire may have an open area of from about 35% and about 65%, in some embodiments from about 40% to about 60%, and in some embodiments, from about 45% to about 55%. Importantly, the forming surface comprises a surface having the inverse texture of the desired multi-textured coform material. Also, forming surface variations may include, but are not limited to, alternate weave patterns, alternate strand dimensions, release coatings (e.g., silicones, fluorochemicals, etc.), static dissipation treatments, and the like. Still other suitable foraminous surfaces that may be employed are described in U.S. Patent Application Publication No. 2007/0049153 to Dunbar, et al.

Regardless of the particular texturing method employed, the offsets formed by the meltblown fibers of the present invention are able to retain the desired shape and surface contour. Namely, because the meltblown fibers crystallize at a relatively slow rate, they are soft upon deposition onto the forming surface, which allows them to drape over and conform to the contours of the surface. After the fibers crystallize, they are then able to hold the shape and form offsets. The size and shape of the resulting offsets depends upon the type of forming surface used, the types of fibers deposited thereon, the volume of below wire air vacuum used to draw the fibers onto and into the forming surface, and other related factors. For example, the offsets may project from the surface of the material in the range of about 0.25 millimeters to at least about 5 millimeters, and in some embodiments, from about 0.5 millimeters to about 3 millimeters. Generally speaking, the offsets are filled with fibers and thus have desirable resiliency useful for wiping and scrubbing.

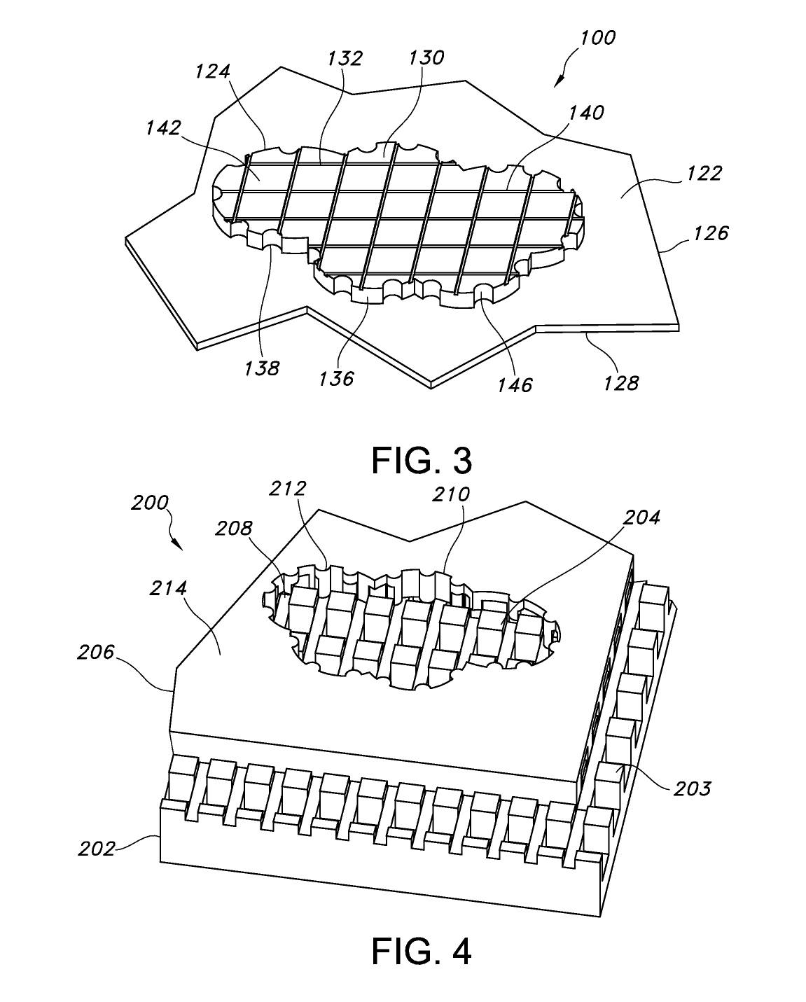

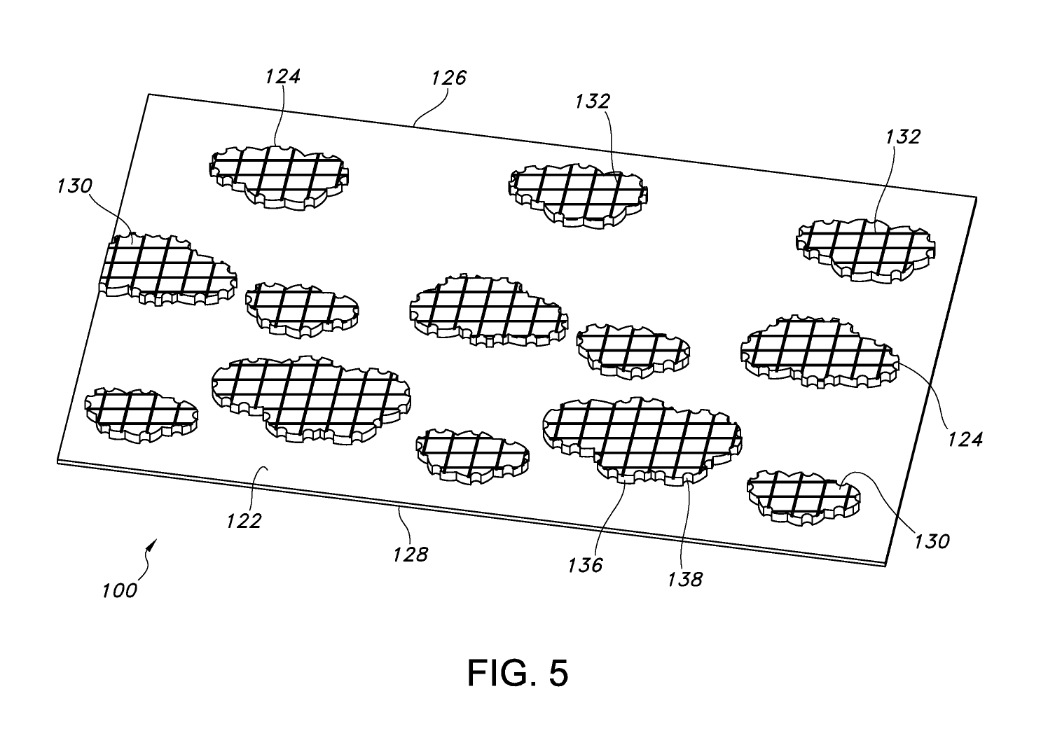

Referring to FIG. 3 and FIG. 5, a multiple-texture coform web 100 has a first exterior surface 122 and a second exterior surface 128. At least one of the exterior surfaces has a three-dimensional surface texture. The coform web 100 is textured in that it includes at least one offset 124 that extends from a continuous region 126 of the coform web, forming a pattern texture. While the offset 124 is depicted as being generally cloud-shaped, the offset 124 may have any of a variety of distinct geometric shapes, for example, circles, squares, ovals, arcs, lines, ridges, and so forth, or the offsets may be in the shape of any other distinct shape, for example, clouds, bears, swooshes, letters, numbers, and so forth.

The at least one offset 124 includes an upper surface 130 that is itself textured in that the upper surface 130 of the offset includes a foundation texture 132. While FIG. 3 depicts a foundation texture 132 that includes raised crossed lines 140 defining recessed squares 142 in the upper surface 130, foundation textures on the surface of the offset may include any distinctive texture, for example, fuzzy texture, rough texture, flat texture, indentation texture, wire texture, dimples, circular dimples, square dimples, pyramids, reverse pyramids, reverse dimples, ovals, arcs, lines, ridges, crossed ridges, channels, other three-dimensional textures, and so forth. In some desirable embodiments the foundation texture 132 is a texture different than a flat texture. The raised crossed lines 140 may have any suitable width, for example, the width may range from about 0.5 millimeters (mm) to about 12 mm, or from about 1 mm to about 8 mm, or from about 2 mm to about 5 mm. The recessed squares 142 may have any suitable side length, for example, the side length may range from about 0.5 mm to about 12 mm, or from about 0.5 mm to about 8 mm, or from about 0.5 mm to about 5 mm.

The at least one offset 124 includes an offset side wall 136 positioned between the upper surface 130 of the offset 124 and the surface of the continuous region 126. The offset side wall 136 includes a wall texture 138. The wall texture 138 may or may not be different than the foundation texture 132. While FIG. 3 depicts a wall texture 138 including channels 146 in the wall 136, the wall texture 138 may include any distinctive texture, for example, fuzzy texture, rough texture, flat texture, indentation texture, wire texture, dimples, circular dimples, square dimples, pyramids, reverse pyramids, channels, angled channels, cross channels, lines, ridges, crossed ridges, other three dimensional textures, and so forth. In some desirable embodiments the wall texture 138 is a texture different than a flat texture. The channels 146 may have any suitable width, for example, the width may range from about 0.5 mm to about 12 mm, or from about 1 mm to about 8 mm, or from about 1 mm to about 5 mm.

Referring to FIG. 4, an exemplary forming surface 200 useful for forming the textured coform 100 depicted in FIG. 3 is shown. The forming surface 200 includes an underlying forming member 202 having an upper surface 203 defining a first texture 204 corresponding to the foundation texture of the textured coform material formed on top of the forming surface 200. By “corresponding” or “corresponds” is meant a mirror image texture that results in the desired texture being formed in the coform material formed on top of the forming surface 200. Overlaying the underlying forming surface 202 is an upper forming member 206 defining one or more voids 208 corresponding to the offsets of the textured coform material formed on top of the forming surface 200. The arrangement of the voids 208 in the upper forming member 206 corresponds to the pattern texture of the textured coform material formed on top of the forming surface 200. The voids 208 are further defined by an upper forming member side wall 210 that corresponds to the offset side wall of the textured coform material formed on top of the forming surface 200. The upper forming member side wall 210 includes an upper forming member side wall texture 212 that corresponds to the wall texture of the textured coform material formed on top of the forming surface 200. The upper forming member 206 further includes an upper surface 214 that may include an upper surface texture (not shown) that corresponds to the secondary texture of the textured coform material formed on top of the forming surface 200. The underlying forming member 202 and the upper forming member 206 may be separate members or may be one contiguous member.

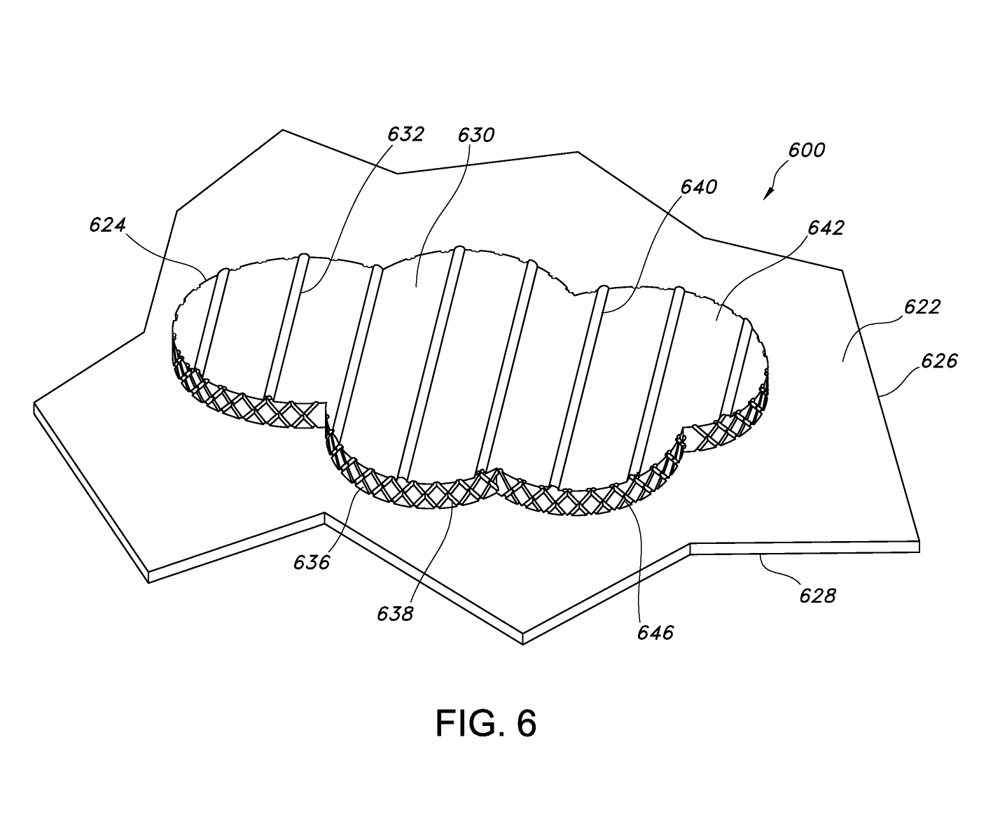

Referring to FIG. 6, a multiple-texture coform web 600 has a first exterior surface 622 and a second exterior surface 628. At least one of the exterior surfaces has a three-dimensional surface texture. The coform web 600 is textured in that it includes at least one offset 624 that extends from a continuous region 626 of the coform web, forming a pattern texture. While the offset 624 is depicted as being generally cloud-shaped, the offset 624 may have any of a variety of distinct geometric shapes, for example, circles, squares, ovals, arcs, lines, ridges, and so forth, or the offsets may be in the shape of any other distinct shape, for example, clouds, bears, swooshes, letters, numbers, and so forth.

The at least one offset 624 includes an upper surface 630 that is itself textured in that the upper surface 630 of the offset includes a foundation texture 632. While FIG. 6 depicts a foundation texture 632 that includes raised ridges 640 defining channels 642 in the upper surface 630, foundation textures on the surface of the offset may include any distinctive texture, for example, fuzzy texture, rough texture, flat texture, indentation texture, wire texture, dimples, circular dimples, square dimples, pyramids, reverse pyramids, reverse dimples, ovals, arcs, lines, ridges, crossed ridges, channels, other three-dimensional textures, and so forth. In some desirable embodiments the foundation texture 632 is a texture different than a flat texture. The raised ridges 640 may have any suitable width, for example, the width may range from about 0.5 mm to about 12 mm, or from about 1 mm to about 8 mm, or from about 2 mm to about 5 mm. The raised ridges 640 may have any suitable height, for example, the height may range from about 0.5 mm to about 12 mm, or from about 0.5 mm to about 8 mm, or from about 0.5 mm to about 5 mm. The channels 642 may have any suitable width, for example, the width may range from about 1 mm to about 25 mm, or from about 2 mm to about 15 mm, or from about 3 mm to about 10 mm.

The at least one offset 624 includes an offset side wall 636 positioned between the upper surface 630 of the offset 624 and the surface of the continuous region 626. The offset side wall 636 includes a wall texture 638. The wall texture 638 may or may not be different than the foundation texture 632. While FIG. 6 depicts a wall texture 638 including crossed channels 646 in the wall 636, the wall texture 638 may include any distinctive texture, for example, fuzzy texture, rough texture, flat texture, indentation texture, wire texture, dimples, circular dimples, square dimples, pyramids, reverse pyramids, channels, angled channels, cross channels, lines, ridges, crossed ridges, other three dimensional textures, and so forth. In some desirable embodiments the wall texture 638 is a texture different than a flat texture. The crossed channels 646 may have any suitable width, for example, the width may range from about 0.5 mm to about 3 mm, or from about 1 mm to about 2 mm.

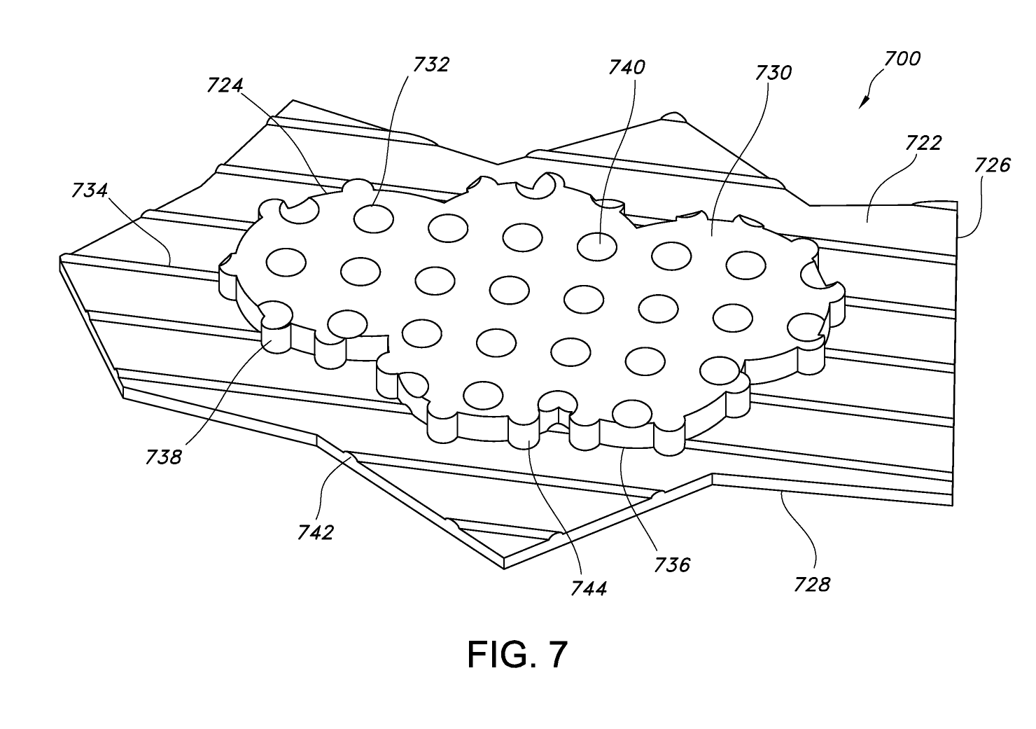

Referring to FIG. 7, a multiple-texture coform web 700 has a first exterior surface 722 and a second exterior surface 728. At least one of the exterior surfaces has a three-dimensional surface texture. The coform web 700 is textured in that it includes at least one offset 724 that extends from a continuous region 726 of the coform web, forming a pattern texture. While the offset 724 is depicted as being generally round, the offset 724 may have any of a variety of distinct geometric shapes, for example, circles, squares, ovals, arcs, lines, ridges, and so forth, or the offsets may be in the shape of any other distinct shape, for example, clouds, bears, swooshes, letters, numbers, and so forth.

The at least one offset 724 includes an upper surface 730 that is itself textured in that the upper surface 730 of the offset includes a foundation texture 732. While FIG. 7 depicts a foundation texture 732 that includes dimples 740 in the upper surface 730, foundation textures on the surface of the offset may include any distinctive texture, for example, fuzzy texture, rough texture, flat texture, indentation texture, wire texture, dimples, circular dimples, square dimples, pyramids, reverse pyramids, reverse dimples, ovals, arcs, lines, ridges, crossed ridges, crossed ridges, channels, other three-dimensional textures, and so forth. In some desirable embodiments the foundation texture 732 is a texture different than a flat texture. The dimples 740 may have any suitable depth, for example, the depth may range from about 0.5 mm to about 10 mm, or from about 1 mm to about 8 mm, or from about 2 mm to about 5 mm. The dimples 740 may have any suitable width, for example, the width may range from about 0.5 mm to about 12 mm, or from about 1 mm to about 8 mm, or from about 1 mm to about 5 mm.

The textured coform 700 also includes a secondary texture 734 formed on the continuous region 726 surrounding the offset 724. While FIG. 7 depicts a secondary texture 734 of raised ridges 742, secondary textures 734 on the surface of the continuous region 726 may include any distinctive texture, for example, fuzzy texture, rough texture, flat texture, indentation texture, wire texture, dimples, circular dimples, square dimples, pyramids, reverse pyramids, reverse dimples, ovals, arcs, lines, ridges, crossed ridges, channels, other three-dimensional textures, and so forth. The secondary texture 734 may or may not be different than the foundation texture 732. In some desirable embodiments the secondary texture 734 is a texture different than a flat texture. The raised ridges 742 may have any suitable width, for example, the width may range from about 0.5 mm to about 12 mm, or from about 1 mm to about 8 mm, or from about 2 mm to about 5 mm. The raised ridges 742 may have any suitable height, for example, the height may range from about 0.5 mm to about 12 mm, or from about 0.5 mm to about 8 mm, or from about 0.5 mm to about 5 mm. The raised ridges 742 may have any suitable spacing between adjacent ridges, for example, the spacing may range from about 1 mm to about 25 mm, or from about 2 mm to about 15 mm, or from about 3 mm to about 10 mm.

The at least one offset 724 includes an offset side wall 736 positioned between the upper surface 730 of the offset 724 and the surface of the continuous region 726. The offset side wall 736 includes a wall texture 738. The wall texture 738 may or not be different than the foundation texture 732. Further, the wall texture 738 may or may not be different than the secondary texture 734. While FIG. 7 depicts a wall texture 738 including columns 744, the wall texture 738 may include any distinctive texture, for example, fuzzy texture, rough texture, flat texture, indentation texture, wire texture, dimples, circular dimples, square dimples, pyramids, reverse pyramids, channels, angled channels, cross channels, lines, ridges, crossed ridges, other three dimensional textures, and so forth. In some desirable embodiments the wall texture 738 is a texture different than a flat texture. The columns 744 may have any suitable width, for example, the width may range from about 0.5 mm to about 12 mm, or from about 1 mm to about 8 mm, or from about 1 mm to about 5 mm.

One indication of the magnitude of three-dimensionality in the textured exterior surface(s) of the coform webs is the peak to valley ratio, which is calculated as the ratio of the overall thickness of the coform web divided by the height of the offsets above the continuous region. The coform web typically has a peak to valley ratio of from about 1.1 to about 15, in some embodiments from about 1.15 to about 10, and in some embodiments, from about 1.2 to about 5. The number and arrangement of the offsets may vary widely depending on the desired end use. In particular embodiments that are more densely textured, the textured coform web may have from about 2 to about 70 offsets per square centimeter, and in other embodiments, from about 5 to about 50 offsets per square centimeter. In certain embodiments that are less densely textured, the textured coform web may have from about 100 to about 20,000 offsets per square meter, and in further embodiments from about 200 to about 10,000 offsets per square meter.

The textured coform web may also include a three-dimensional texture on the side of the web opposite the offsets. This will especially be the case for lower basis weight materials, such as those having a basis weight of less than about 70 grams per square meter due to “mirroring”, wherein the side of the web opposite the offsets exhibits secondary offsets positioned between the offsets on the opposite surface of the material. In this case, the valley depth is measured for both exterior surfaces as above and are then added together to determine an overall material valley depth.

In some embodiments, the various textures may be configured to assist the absorption of fluid into the coform material. For example, foundation or secondary textures that include dimples or indentations may tend to collect fluid and enhance absorption. As another example, side wall textures that include channels, columns, or other linear textures may enhance the flow of liquid down the offset side wall. As a further example, foundation or secondary textures that include channels, dams, lines, linear textures, and so forth, may enhance the flow of liquid across the surface of the coform nonwoven material.

It should be recognized that the various textures described herein may be mixed and matched on the various surfaces of the coform nonwoven material. For example, foundation textures may be utilized as secondary textures or side wall textures, secondary textures may be utilized as foundation textures or side wall textures, side wall textures may be utilized as foundation textures or secondary textures, and so forth. The secondary texture may be the same as or different than the foundation texture. The secondary texture may also be the same as or different than the wall texture. The foundation texture may be the same as or different than the secondary texture. The foundation texture may also be the same as or different than the wall texture. The wall texture may be the same as or different than the secondary texture. The wall texture may also be the same as or different than the foundation texture.

### V. Articles

The coform nonwoven web may be used in a wide variety of articles. For example, the web may be incorporated into an “absorbent article” that is capable of absorbing water or other fluids. Examples of some absorbent articles include, but are not limited to, personal care absorbent articles, such as diapers, training pants, absorbent underpants, incontinence articles, feminine hygiene products (e.g., sanitary napkins), swim wear, baby wipes, mitt wipe, and so forth; medical absorbent articles, such as garments, fenestration materials, underpads, bedpads, bandages, absorbent drapes, and medical wipes; food service wipers; clothing articles; pouches, and so forth. Materials and processes suitable for forming such articles are well known to those skilled in the art.

In one particular embodiment of the present invention, the coform web is used to form a wipe. The wipe may be formed entirely from the coform web or it may contain other materials, such as films, nonwoven webs (e.g., spunbond webs, meltblown webs, carded web materials, other coform webs, airlaid webs, etc.), paper products, and so forth. In one embodiment, for example, two layers of a textured coform web may be laminated together to form the wipe, such as described in U.S. Patent Application Publication No. 2007/0065643 to Kopacz, which is incorporated herein in its entirety by reference thereto for all purposes. In such embodiments, one or both of the layers may be formed from the coform web of the present invention. In another embodiment, it may be desired to provide a certain amount of separation between a user's hands and a moistening or saturating liquid that has been applied to the wipe, or, where the wipe is provided as a dry wiper, to provide separation between the user's hands and a liquid spill that is being cleaned up by the user. In such cases, an additional nonwoven web or film may be laminated a surface of the coform web to provide physical separation and/or provide liquid barrier properties. Other fibrous webs may also be included to increase absorbent capacity, either for the purposes of absorbing larger liquid spills, or for the purpose of providing a wipe a greater liquid capacity. When employed, such additional materials may be attached to the coform web using any method known to one skilled in the art, such as by thermal or adhesive lamination or bonding with the individual materials placed in face to face contacting relation. Regardless of the materials or processes utilized to form the wipe, the basis weight of the wipe is typically from about 20 to about 200 grams per square meter (gsm), and in some embodiments, between about 35 to about 100 gsm. Lower basis weight products may be particularly well suited for use as light duty wipes, while higher basis weight products may be better adapted for use as industrial wipes.

The wipe may assume a variety of shapes, including but not limited to, generally circular, oval, square, rectangular, or irregularly shaped. Each individual wipe may be arranged in a folded configuration and stacked one on top of the other to provide a stack of wet wipes. Such folded configurations are well known to those skilled in the art and include c-folded, z-folded, quarter-folded configurations and so forth. For example, the wipe may have an unfolded length of from about 2.0 to about 80.0 centimeters, and in some embodiments, from about 10.0 to about 25.0 centimeters. The wipes may likewise have an unfolded width of from about 2.0 to about 80.0 centimeters, and in some embodiments, from about 10.0 to about 25.0 centimeters. The stack of folded wipes may be placed in the interior of a container, such as a plastic tub, to provide a package of wipes for eventual sale to the consumer. Alternatively, the wipes may include a continuous strip of material which has perforations between each wipe and which may be arranged in a stack or wound into a roll for dispensing. Various suitable dispensers, containers, and systems for delivering wipes are described in U.S. Pat. No. 5,785,179 to Buczwinski, et al.; U.S. Pat. No. 5,964,351 to Zander; U.S. Pat. No. 6,030,331 to Zander; U.S. Pat. No. 6,158,614 to Haynes, et al.; U.S. Pat. No. 6,269,969 to Huang, et al.; U.S. Pat. No. 6,269,970 to Huang, et al.; and U.S. Pat. No. 6,273,359 to Newman, et al., which are incorporated herein in their entirety by reference thereto for all purposes.

In certain embodiments of the present invention, the wipe is a “wet” or “premoistened” wipe in that it contains a liquid solution for cleaning, disinfecting, sanitizing, etc. The particular liquid solutions are not critical and are described in more detail in U.S. Pat. No. 6,440,437 to Krzysik, et al.; U.S. Pat. No. 6,028,018 to Amundson, et al.; U.S. Pat. No. 5,888,524 to Cole; U.S. Pat. No. 5,667,635 to Win, et al.; and U.S. Pat. No. 5,540,332 to Kopacz, et al., which are incorporated herein in their entirety by reference thereto for all purposes. The amount of the liquid solution employed may depending upon the type of wipe material utilized, the type of container used to store the wipes, the nature of the cleaning formulation, and the desired end use of the wipes. Generally, each wipe contains from about 150 to about 600 wt. % and desirably from about 300 to about 500 wt. % of a liquid solution based on the dry weight of the wipe.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A coform nonwoven web comprising a matrix of meltblown fibers and an absorbent material, the matrix comprising a continuous region and a plurality of offset regions, the offset regions extending from the continuous region, wherein the offset regions define a foundation texture on a surface of the offset region, further wherein the continuous region defines a secondary texture different from the foundation texture.

2. The coform nonwoven web of claim 1, wherein the thickness of the continuous region is from about 0.01 millimeters to about 1.0 millimeters.

3. The coform nonwoven web of claim 1, wherein the density of the continuous region is substantially equal to the density of the offset regions.

4. The coform nonwoven web of claim 1, wherein the offset regions extend from the first side by from about 0.01 millimeters to about 1.0 millimeters.

5. The coform nonwoven web of claim 1, wherein the offset regions include a side wall having a side wall texture different than the foundation texture.

6. The coform nonwoven web of claim 5, wherein the side wall texture is different than the secondary texture.

7. The coform nonwoven web of claim 1, wherein the foundation texture and secondary texture are selected from the group consisting of fuzzy texture, rough texture, flat texture, indentation texture, wire texture, dimples, circular dimples, square dimples, pyramids, reverse pyramids, reverse dimples, ovals, arcs, lines, ridges, and channels.

8. The coform nonwoven web of claim 1 wherein the meltblown fibers comprise a thermoplastic composition that contains at least one propylene/α-olefin copolymer having a propylene content of from about 60 mole % to about 99.5 mole % and an α-olefin content of from about 0.5 mole % to about 40 mole %, wherein the copolymer further has a density of from about 0.86 to about 0.90 grams per cubic centimeter and the composition has a melt flow rate of from about 120 to about 6000 grams per 10 minutes, determined at 230° C. in accordance with ASTM Test Method D1238-E.

9. The coform nonwoven web of claim 8, wherein the α-olefin includes ethylene.

10. The coform nonwoven web of claim 8, wherein propylene constitutes from about 85 mole % to about 98 mole % of the copolymer and the α-olefin constitutes from about 2 mole % to about 15 mole % of the copolymer.

11. The coform nonwoven web of claim 8, wherein the copolymer has a density of from about 0.861 to about 0.89 grams per cubic centimeter, and preferably from about 0.862 to about 0.88 grams per cubic centimeter.

12. The coform nonwoven web of claim 1, wherein the absorbent material contains pulp fibers.

13. A wipe comprising the coform nonwoven web of any of the foregoing claims.

14. The wipe of claim 13, wherein the wipe contains from about 150 to about 600 wt. % of a liquid solution based on the dry weight of the wipe.

15. A coform nonwoven web comprising a matrix of meltblown fibers and an absorbent material, the matrix comprising a continuous region and a plurality of offset regions, the offset regions extending from the continuous region, wherein the offset regions include an upper surface and a side wall, and further wherein the upper surface defines a foundation texture and the side wall defines a side wall texture different than the foundation texture.

16. The coform nonwoven web of claim 15, therein the continuous region defines a surface having a secondary texture different than the foundation texture.

17. The coform nonwoven web of claim 16, wherein the foundation texture and secondary texture are selected from the group consisting of fuzzy texture, rough texture, flat texture, indentation texture, wire texture, dimples, circular dimples, square dimples, pyramids, reverse pyramids, reverse dimples, ovals, arcs, lines, ridges, crossed ridges, and channels.

18. The coform nonwoven web of claim 15, wherein the side wall texture is selected from the group consisting of fuzzy texture, rough texture, flat texture, indentation texture, wire texture, dimples, circular dimples, square dimples, pyramids, reverse pyramids, channels, angled channels, cross channels, lines, ridges, and crossed ridges.

19. The coform nonwoven web of claim 15, wherein the density of the continuous region is substantially equal to the density of the offset regions.

20. A coform nonwoven web comprising a matrix of meltblown fibers and an absorbent material, the matrix comprising a continuous region and a plurality of offset regions, the offset regions extending from the continuous region, wherein the offset regions include an upper surface defining a foundation texture and a side wall defining a side wall texture different than the foundation texture, and further wherein the continuous region defines a secondary texture different than the foundation texture.
